(19) United States
(12) Patent Application Publication
(10) Pub. No.: US 2019/0378339 A1
(43) Pub. Date: Dec. 12, 2019

(54) METHOD FOR IMPLEMENTING AUGMENTED REALITY IMAGE USING VECTOR

(71) Applicant: Likersnet Co., Ltd., Seoul (KR)

(72) Inventor: Seung Hak LEE, Yongin-si (KR)

(73) Assignee: Likersnet Co., Ltd., Seoul (KR)

(21) Appl. No.: 16/551,039

(22) Filed: Aug. 26, 2019

Related U.S. Application Data
(63) Continuation of application No. PCT/KR2018/003188, filed on Mar. 19, 2018.

(30) Foreign Application Priority Data
Mar. 20, 2017 (KR) 10-2017-0034397
Aug. 14, 2017 (KR) 10-2017-0102891
Sep. 11, 2017 (KR) 10-2017-0115841

(51) Int. Cl. G06T 19/00; G06T 7/70

(52) U.S. Cl. CPC G06T 19/006; G06T 2200/24; G06T 7/70

(57) ABSTRACT

Provided is a computing device-implemented method for implementing an augmented reality image. The method for implementing an augmented reality image comprises the steps of: acquiring a first layer indicating a real world image acquired by a computing device; identifying at least one object contained in the first layer; determining a first marker image on the basis of an image corresponding to the at least one object among previously stored images; matching positions of the first marker image and the at least one object; generating a second layer on the basis of the first marker image; generating an augmented reality image through composition of the first layer and the second layer; and outputting the augmented reality image.

### CROSS-REFERENCE TO RELATED APPLICATIONS

The present application is a continuation of International Patent Application No. PCT/KR2018/003188, filed Mar. 19, 2018, which is based upon and claims the benefit of priority to Korean Patent Application Nos. 10-2017-0034397, 10-2017-0102891 and 10-2017-0115841, filed on Mar. 20, 2017, Aug. 14, 2017 and Sep. 11, 2017, respectively. The disclosures of the above-listed applications are hereby incorporated by reference herein in their entirety.

### BACKGROUND

Embodiments of the inventive concept described herein relate to a method for implementing an augmented reality image using a vector.

The augmented reality refers to a computer graphic technology that displays one image obtained by mixing a real-world image, which a user watches, and a virtual image. The augmented reality may be obtained by composing images of virtual objects or information and specific objects of real world images.

Conventionally, a marker image or position information (e.g., GPS position information) has been used to identify an object to be composed with a virtual image. In the case of using a marker image, the camera of the computing device fails to accurately capture the marker image due to the hand shaking of a user. Accordingly, the augmented reality image is not implemented elaborately. In the meantime, in the case of using position information, the augmented reality image is not implemented due to the limitation or the malfunction of recognition of the GPS position of the computing device depending on the influence of the surrounding environment, or the like.

Accordingly, a method for implementing an augmented reality image independent of a marker image and position information is required.

There is a prior art disclosed as Korean Patent Publication No. 10-2016-0081381 issued on Jul. 8, 2016

### SUMMARY

Embodiments of the inventive concept provide a method for implementing an augmented reality image that prevents the augmented reality content from being disconnected as the marker image is shaken.

The technical problems to be solved by the present inventive concept are not limited to the aforementioned problems, and any other technical problems not mentioned herein will be clearly understood from the following description by those skilled in the art to which the inventive concept pertains.

According to an exemplary embodiment, a method for implementing an augmented reality image includes acquiring a first layer indicating a real world image acquired by a computing device, identifying at least one object contained in the first layer, determining a first marker image based on an image corresponding to the at least one object in a previously stored image, matching a position of the first marker image with the at least one object, generating a second layer based on the first marker image, generating an augmented reality image through composition of the first layer and the second layer, and outputting the augmented reality image.

Herein, the method further may include providing a user with the previously stored image, acquiring a user command including image information from the user, and determining a second marker image based on the image information. The generating of the second layer may include further considering the second marker image.

Herein, the previously stored image may include an outline vector value.

Herein, the user command may include outline vector information of an image to be used as the second marker image.

Herein, the user command may include information of an inner point and an outer point of an image to be used as the second marker image.

Herein, the first marker image may be transparently generated to be recognized by the computing device without being recognized by a user.

Herein, the second layer may include augmented reality content corresponding to at least one of the first marker image and the second marker image, and the augmented reality content may mean a virtual image that appears in the augmented reality image.

Herein, an object placement state of the first layer may be identified based on a vector. A form of providing the augmented reality content may be determined based on the object placement state.

According to an exemplary embodiment, a computer-readable medium recording a program for performing the described method of implementing an augmented reality image may be included.

According to an exemplary embodiment, an application for a terminal device stored in a medium to perform the described method for implementing an augmented reality image in combination with the computing device that is a piece of hardware may be included.

Other specific details of the inventive concept are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a conceptual diagram for describing a method for implementing a virtual reality image, according to an embodiment of the inventive concept;

FIG. 2 is a block diagram illustrating an inside of a terminal providing augmented reality;

FIG. 3 is a flowchart illustrating an augmented reality providing method according to a first embodiment; and

FIG. 4 is a flowchart illustrating an augmented reality providing method according to a second embodiment.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, embodiments of the inventive concept will be described in detail with reference to accompanying drawings.

According to an embodiment of the inventive concept, the method for implementing an augmented reality image using a vector is implemented by a computing device. The method for implementing an augmented reality image may be implemented with an application, may be stored in a computing device, and may be performed by the computing device.

For example, the computing device may be provided as, but not limited to, a mobile device such as a smartphone, a tablet PC, or the like and only needs to be equipped with a camera and to process and store data. That is, the computing device may be provided as a wearable device equipped with a camera, such as glasses, a band, or the like. The arbitrary computing device not illustrated may be provided.

Although not illustrated explicitly, the computing device may communicate with other computing devices or servers over a network. In some embodiments, the method for implementing an augmented reality image may be implemented by linking the computing device to another computing device or a server.

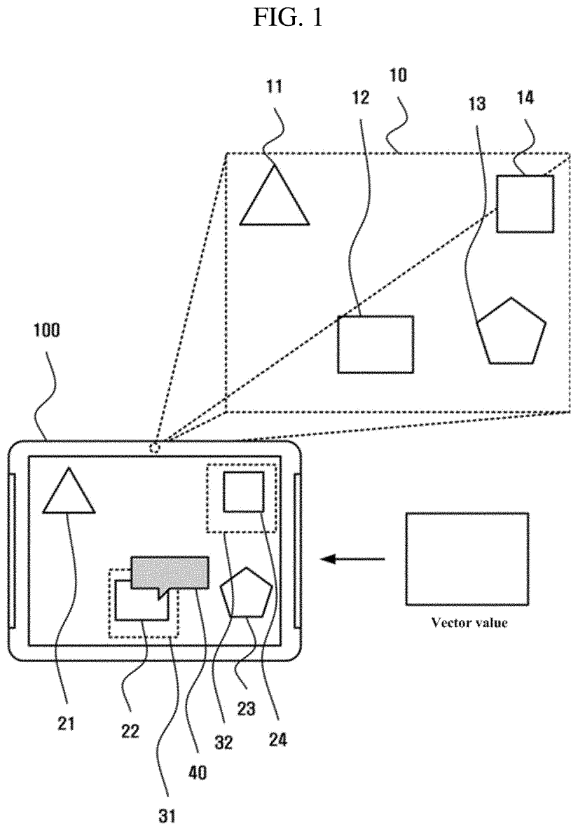

Referring to FIG. 1, a computing device 100 captures a real world space 10 to acquire a real world image. For example, it is assumed that there are a plurality of real objects 11, 12, 13, and 14 in the real world space 10. The plurality of real objects 11, 12, 13, and 14 may include a two-dimensional or three-dimensional object. The plurality of real objects 11, 12, 13, and 14 may have different or similar shapes. The computing device 100 may distinguish an object based on these morphologic differences.

The computing device 100 may identify a plurality of objects 21, 22, 23, and 24 in the real world image. The computing device 100 may extract the outlines of the identified plurality of objects 21, 22, 23, and 24. Moreover, the computing device 100 determines an object, which is matched with the pre-stored image, from among the objects 21, 22, 23, and 24 using the vector value of the outline of the pre-stored image.

The computing device 100 may store an image sample corresponding to the plurality of objects 21, 22, 23, and 24 in advance. Data of the outline of the image sample corresponding to the plurality of objects 21, 22, 23, and 24 may be stored in advance.

For example, when the first object 21 has the shape of a mountain, the computing device 100 may read an image sample similar to the shape of the pre-stored first object 21. The computing device 100 may use a pre-stored image sample as a marker image to be described below.

The type of marker image may include a first marker image and a second marker image. The first marker image may indicate a marker image obtained based on the first layer to be described below. That is, the first marker image may indicate a marker image, which is not determined from the user but determined based on the real image. For example, it is assumed that there are a calendar and frame that are distinguished from the background in the first layer reflecting the real image. Herein, the first marker image may be a transparent marker generated based on the outline and shape of each of the calendar and frame in the first layer. Herein, the marker may generate augmented reality content later.

The second marker image may indicate the marker image acquired based on the information received from a user. For example, the user may allow the augmented reality content (stars, explosion shapes, characters, or the like) to appear on the display screen. In this case, the second marker image may be used in a procedure in which the user allows the augmented reality content to appear. Herein, the second marker image may be a transparent marker previously stored based on the outline and shape of the augmented reality content (stars, explosion shapes, characters, or the like) in the first layer.

In some embodiments, data of outlines of the plurality of objects 21, 22, 23, and 24 may be provided in a three-dimensional type. The data of the images or outlines of the plurality of objects 21, 22, 23, and 24 may be transmitted from another computing device or a server to the computing device 100 and then may be stored. Meanwhile, the images of the plurality of objects 21, 22, 23, and 24 captured by the user may be stored in advance in the computing device 100. Moreover, the data of the extracted outline of an object may be stored in the form of a vector value, that is, a vector image. Herein, the user may indicate a user implementing the augmented reality via the computing device 100.

According to an embodiment of the inventive concept, in a method for implementing an augmented reality image, because a vector image instead of a bitmap image is used, it is possible to elaborately implement an augmented reality image. Even though the distance, the direction, the position, or the like of an object from the computing device 100 is changed depending on the capture environment of the real world, it is possible to accurately identify an object in the real world image, by appropriately changing the vector image of the object (i.e., by corresponding to various types of objects capable of being captured in the real world).

The computing device 100 determines the object 22, which is matched with the object, from among the plurality of objects 21, 22, 23, and 24 and composes the determined object 22 and the virtual image 40 at a periphery of the determined object 22 to implement the augmented reality image.

In some embodiments, a user may designate at least one area 31 or 32 in the real world image. The computing device 100 may set the object 22 or 24 in the area 31 or 32 designate by the user to an object candidate and may determine whether the corresponding object 22 or 24 is matched with an object. Alternatively, in substantially the same manner, a user may designate at least one object 22 or 24 in the real world image to an object candidate.

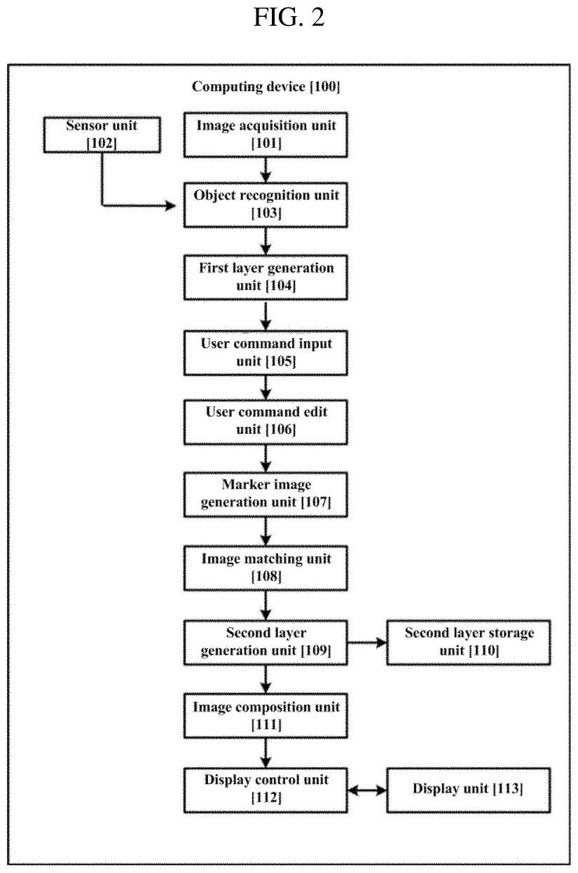

Referring to FIG. 2, the computing device 100 may include at least one of an image acquisition unit 101, a sensor unit 102, an object recognition unit 103, a first layer generation unit 104, a user command input unit 105, a user command edit unit 106, a marker image generation unit 107, an image matching unit 108, a second layer generation unit 109, a second layer storage unit 110, an image composition unit 111, a display control unit 112, or a display unit 113. Each of the components may be controlled by a processor (not illustrated) included in the computing device 100.

The image acquisition unit 101 may capture a real world image. The image acquisition unit 101 may obtain the real world image through shooting. The real world image may include the plurality of real objects 11, 12, 13, and 14. The plurality of real objects 11, 12, 13, and 14 may include a two-dimensional or three-dimensional object. The plurality of real objects 11, 12, 13, and 14 may have different or similar shapes. The image acquisition unit 101 may be a camera or the like.

The sensor unit 102 may be equipped with devices supporting global positioning system (GPS). The sensor unit 102 may recognize the position of an image to be captured, the direction in which the computing device 100 captures an object, the moving speed of the computing device 100, or the like.

The object recognition unit 103 may recognize the plurality of real objects 11, 12, 13, and 14, based on the outlines of the plurality of real objects 11, 12, 13, and 14 included in the real world image. The object recognition unit 103 may recognize the plurality of real objects 11, 12, 13, and 14 based on the outlines of the plurality of real objects 11, 12, 13, and 14 and may generate the plurality of objects 21, 22, 23, and 24 corresponding to the plurality of real objects 11, 12, 13, and 14 in the computing device 100.

The first layer generation unit 104 may generate the first layer indicating the real image corresponding to the real world image. The augmented reality image may be implemented by composing a real image and a virtual image. In the inventive concept, the first layer generation unit 104 may generate the real image based on the real world image captured by the image acquisition unit 101.

The user command input unit 105 may receive a command for outputting another object distinguished from the plurality of objects 21, 22, 23, and 24, from a user employing the computing device 100. For example, the user may recognize the plurality of objects 21, 22, 23, and 24 from the computing device 100. When the user desires to change the first object 21 to another object, the user may enter a command for making a requesting for changing the first object 21 to another object previously stored, into the computing device 100. Alternatively, the user may enter a command for making a requesting for changing the first object 21 to an object, which is to be entered (or drawn) into the computing device 100 by the user, into the computing device 100. The user command may include information of the inner point and the outer point of the image to be used as the marker image.

The user command edit unit 106 may edit at least one object of the plurality of objects 21, 22, 23, and 24 based on the user command obtained from the user command input unit 105.

For example, when the user command input unit 105 receives a command for making a requesting for changing the first object 21 to another pre-stored object from the user, the user command edit unit 106 may perform editing for changing the first object 21 to the other pre-stored object.

The marker image generation unit 107 may generate a marker image based on the plurality of objects 21, 22, 23, and 24. Herein, the marker image may be an image for generating augmented reality content.

For example, the computing device 100, which provides a virtual reality image where the stone included in the real image turns into gold, is assumed. When it is assumed that the second the object 22 is stone, the marker image generation unit 107 may generate a marker image capable of generating gold based on the vector value of the second the object 22.

Herein, the marker image may be recognized by the computing device 100. The marker image may be generated transparently not to be recognized by the user.

The image matching unit 108 may match the marker images of the generated plurality of objects 21, 22, 23, and 24 with the positions of the plurality of objects 21, 22, 23, and 24. When the positions of the plurality of objects 21, 22, 23, and 24 are changed in real time, the image matching unit 108 may move the positions of marker images so as to be matched with the plurality of objects 21, 22, 23, and 24.

The second layer generation unit 109 may recognize the generated marker images of the plurality of objects 21, 22, 23, and 24. The second layer generation unit 109 may generate a second layer with which the augmented reality content corresponding to the position of each of the marker images of the generated plurality of objects 21, 22, 23, and 24 is combined. The augmented reality content may be identified by the user.

The second layer storage unit 110 may store the second layer generated from the second layer generation unit 109. Even when positions of the plurality of objects 21, 22, 23, and 24 are changed in real time due to the second layer generated based on the marker image, the seamlessly continuous screens may be provided to the user.

The image composition unit 111 may generate the augmented reality image by composing the first layer and the second layer. That is, the augmented reality image may be an image in which the augmented reality content is included in the real world image. For example, when stone is present in the real world image obtained through the computing device 100, the image composition unit 111 may generate an image in which only the corresponding stone is displayed as gold.

The display control unit 112 may control the display unit 113 to output the augmented reality image. The display unit 113 may output the augmented reality image through a visual screen.

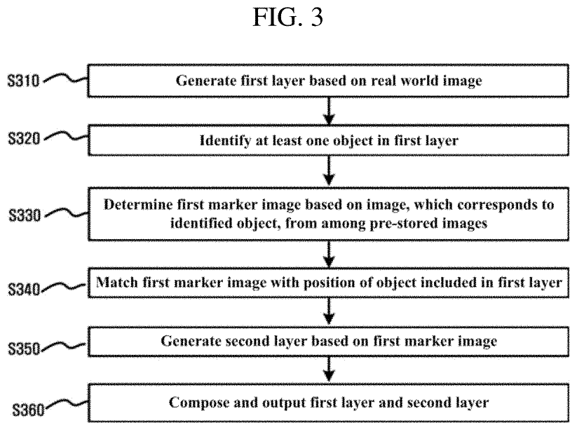

FIG. 3 illustrates an operation of the computing device 100 when there is no user command Referring to FIG. 3, in operation S310, the computing device 100 may generate a first layer based on a real world image. In operation S320, the computing device 100 may identify at least one object in the first layer. The computing device 100 may extract the color of the first layer, the resolution of the first layer, the vector value of an outline of the first layer, or the like.

The computing device 100 may identify at least one object in the first layer, based on the color of the first layer, the resolution of the first layer, the vector value of an outline of the first layer, or the like. The detailed process of identifying an object may be as follows. The computing device 100 may divide an image based on the resolution of the first layer. The computing device 100 may classify the divided image for each area. When the divided image is greater than the preset number, the computing device 100 may merge a hierarchical area through resolution adjustment. For example, the computing device 100 may allow the number of divided areas to be reduced to the lower number, by lowering the resolution of the first layer. The computing device 100 may extract an object capable of being independently recognized, from the divided images.

In operation S330, the computing device 100 may determine a first marker image based on an image, which corresponds to the identified object, from among the previously stored images.

In operation S340, the computing device 100 may match a first marker image with the position of an object included in the first layer. In operation S350, the computing device 100 may generate a second layer including augmented reality content, based on the first marker image.

The computing device 100 may generate the augmented reality image by composing the first layer and the second layer. Because the augmented reality content is generated based on the first marker image formed based on the first layer instead of a first layer, the seamless augmented reality image including augmented reality content may be generated even when the first layer is shaken due to hand shaking. When the position of the first layer or the angle at which the first layer is viewed is changed, the computing device 100 may compensate for the vector value corresponding to the changed position or the changed angle with respect to the first marker image stored using a vector value of an object in the first layer, the position vector value of an object in a real world, the normal vector value of an object, or the like.

For example, when only the position of the computing device 100 is changed while the computing device 100 captures a frame in the real world, the angle at which the frame is viewed may be changed. In this case, the computing device 100 may compensate for the vector value of the first marker image, using the vector value of the first marker image corresponding to the frame, the position vector value of the frame in the real world, the normal vector value of the frame, or the like.

In operation S360, the computing device 100 may visually output an augmented reality image through the display unit 113.

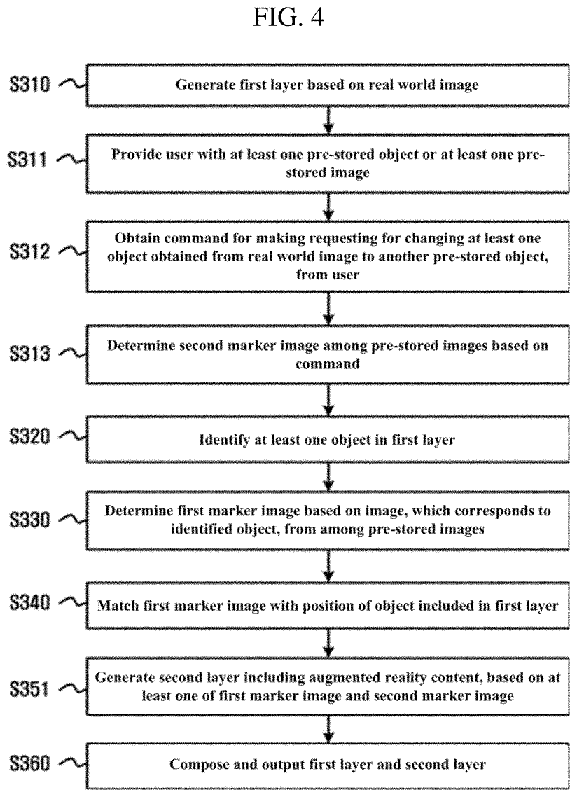

FIG. 4 illustrates an operation of the computing device 100 when a user command is present. Referring to FIG. 4, in operation S310, the computing device 100 may generate a first layer based on a real world image.

In operation S311, the computing device 100 may provide a user with at least one pre-stored object or at least one pre-stored image. When the request of a user is present, the computing device 100 may provide the user with the at least one pre-stored object (or image). Alternatively, even though the request of a user is not present, the computing device 100 may automatically provide the user with the at least one pre-stored object (image).

The user that identifies the at least one pre-stored object (or image) through the computing device 100 may enter a command for making a requesting for changing at least one object obtained from a real world image to another pre-stored object, into the computing device 100. The user may directly enter (or draw) an object into the computing device 100.

In operation S312, the computing device 100 may obtain the command for making a requesting for changing at least one object obtained from the real world image to another pre-stored object, from the user. Alternatively, the computing device 100 may obtain the command for making a requesting for changing at least one object obtained from the real world image to the object directly entered (or drawn) by the user into the computing device 100, from the user.

In operation S313, the computing device 100 may determine a second marker image among pre-stored images based on a command. In operation S320, the computing device 100 may identify at least one object in the first layer. The computing device 100 may extract the color of the first layer, the resolution of the first layer, the vector value of an outline of the first layer, or the like.

The computing device 100 may identify at least one object in the first layer, based on the color of the first layer, the resolution of the first layer, the vector value of an outline of the first layer, or the like. The detailed process of identifying an object may be as follows. The computing device 100 may divide an image based on the resolution of the first layer. The computing device 100 may classify the divided image for each area. When the divided image is greater than the preset number, the computing device 100 may merge a hierarchical area through resolution adjustment. For example, the computing device 100 may allow the number of divided areas to be reduced to the lower number, by lowering the resolution of the first layer. The computing device 100 may extract an object capable of being independently recognized, from the divided images.

In operation S330, the computing device 100 may determine a first marker image based on an image, which corresponds to the identified object, from among the previously stored images.

In operation S340, the computing device 100 may match a first marker image with the position of an object included in the first layer. In operation S351, the computing device 100 may generate a second layer including augmented reality content, based on at least one of the first marker image and the second marker image.

The computing device 100 may generate the augmented reality image by composing the first layer and the second layer. Because the augmented reality content is generated based on at least one of the first marker image formed based on the first layer instead of a first layer and the second marker image formed based on the user command, the seamless augmented reality image including augmented reality content may be generated even when the first layer is shaken due to hand shaking. When the position of the first layer or the angle at which the first layer is viewed is changed, the computing device 100 may compensate for the vector value corresponding to the changed position or the changed angle with respect to the first marker image or the second marker image stored using a vector value of an object in the first layer, the position vector value of an object in a real world, the normal vector value of an object, or the like.

For example, when only the position of the computing device 100 is changed while the computing device 100 captures a frame in the real world, the angle at which the frame is viewed may be changed. In this case, the computing device 100 may compensate for the vector value of the first marker image, using the vector value of the first marker image corresponding to the frame, the position vector value of the frame in the real world, the normal vector value of the frame, or the like.

The computing device 100 may generate the augmented reality image by composing the first layer and the second layer. In operation S360, the computing device 100 may visually output an augmented reality image through the display unit 113.

According to an embodiment of the inventive concept, a method for implementing an augmented reality image may be implemented by a program (or an application) and may be stored in a medium such that the program is executed in combination with a computer being hardware.

The above-described program may include a code encoded by using a computer language such as C, C++, JAVA, a machine language, or the like, which a processor (CPU) of the computer can read through the device interface of the computer, such that the computer reads the program and performs the methods implemented with the program. The code may include a functional codes associated with the function that defines functions necessary to perform the methods, and may include a control code associated with an execution procedure necessary for the processor of the computer to perform the functions in a predetermined procedure. Furthermore, the code may further include additional information necessary for the processor of the computer to perform the functions or a memory reference-related code associated with the location (address) of the internal or external memory of the computer, at which the media needs to be checked. Moreover, when the processor of the computer needs to communicate with any other remote computer or any other remote server to perform the functions, the code may further include a communication-related code associated with how to communicate with any other remote computer or server using the communication module of the computer, what information or media should be transmitted or received during communication, or the like.

The stored media may mean the media that does not store data for a short period of time such as a register, a cache, a memory, or the like but semi-permanently stores to be read by the device. Specifically, for example, the stored media include, but are not limited to, ROM, RAM, CD-ROM, magnetic tape, floppy disk, optical data storage device, and the like. That is, the program may be stored in various recording media on various servers that the computer can access, or various recording media on the computer of the user. In addition, the media may be distributed to a computer system connected to a network, and a computer-readable code may be stored in a distribution manner.

Although embodiments of the inventive concept have been described herein with reference to accompanying drawings, it should be understood by those skilled in the art that the inventive concept may be embodied in other specific forms without departing from the spirit or essential features thereof. Therefore, it should be understood that the above embodiments are not limiting, but illustrative.

According to the inventive concept, the augmented reality content may be prevented from being disconnected as a marker image is shaken in the augmented reality image.

The effects of the inventive concept are not limited to the aforementioned effects, and other effects not mentioned herein will be clearly understood from the following description by those skilled in the art to which the inventive concept pertains.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for implementing an augmented reality image, the method comprising:
acquiring a first layer indicating a real world image acquired by a computing device;
identifying at least one object contained in the first layer;
determining a first marker image based on an image corresponding to the at least one object in a previously stored image;
matching a position of the first marker image with the at least one object;
generating a second layer based on the first marker image;
generating an augmented reality image through composition of the first layer and the second layer; and
outputting the augmented reality image.

2. The method of claim 1, further comprising:
providing a user with the previously stored image;
acquiring a user command including image information from the user; and
determining a second marker image based on the image information, wherein the generating of the second layer includes further considering the second marker image.

3. The method of claim 1, wherein the previously stored image includes an outline vector value.

4. The method of claim 2, wherein the user command includes outline vector information of an image to be used as the second marker image.

5. The method of claim 2, wherein the user command includes information of an inner point and an outer point of an image to be used as the second marker image.

6. The method of claim 1, wherein the first marker image is transparently generated to be recognized by the computing device without being recognized by a user.

7. The method of claim 2, wherein the second layer includes augmented reality content corresponding to at least one of the first marker image and the second marker image, and
wherein the augmented reality content means a virtual image that appears in the augmented reality image.

8. The method of claim 7, wherein an object placement state of the first layer is identified based on a vector, and
wherein a form of providing the augmented reality content is determined based on the object placement state.

9. A computer-readable medium recording a program for performing a method of implementing an augmented reality image, which is described in claim 1.

10. An application for a terminal device stored in a medium to perform a method for implementing an augmented reality image, which is described in claim 1, in combination with the computing device that is a piece of hardware.
